(19) United States
(12) Patent Application Publication
(10) Pub. No.: US 2007/0061764 A1
(43) Pub. Date: Mar. 15, 2007

(54) KEYWORD-BASED CONNECTIVITY VERIFICATION

(75) Inventors: Janice M. Adams, Jericho, VT (US); Michael R. Ouellette, Westford, VT (US); Bruce D. Raymond, Pleasant Valley, NY (US)

Correspondence Address: HOFFMAN, WARNICK & D'ALESSANDRO LLC, 75 STATE ST, 14TH FLOOR, ALBANY, NY, 12207, US

(73) Assignee: INTERNTIONAL BUSINESS MACHINES CORPORATION, Armonk, NY (US)

(21) Appl. No.: 11/162,583

(22) Filed: Sep. 15, 2005

(51) Int. Cl. G06F 17/50

(52) U.S. Cl. 716/5

(57) ABSTRACT

Keyword-based verification of proper connectivity of a circuit design including a plurality of cells is disclosed. In one embodiment, a method includes assigning a keyword to each relevant pin of the circuit design, the keyword indicates a verification rule for a domain starting at the relevant pin; tracing the domain starting at the relevant pin, including recording a circuit instance identifier of each cell encountered to generate a traced circuit instance set; and verifying proper connectivity using the verification rule and the traced circuit instance set. The keyword may also indicate a name that drives the creation of a domain, or a trace rule that instructs the tracing. If the traced circuit instance sets do not match the pre-defined relationships, the verification fails and the user is notified that the logic must be modified. The keyword-based verification can occur between domains of the same circuit or a traced circuit instance set can be compared to an expected set.

### BACKGROUND OF THE INVENTION

1. Technical Field

The invention relates generally to integrated circuit fabrication, and more particularly, to connectivity verification using keywords.

2. Background Art

In application specific integrated circuit (ASIC) fabrication settings, a customer of a fabricator typically provides a certain amount of logic content, and the fabricator then must add support logic to monitor or control the manufacturing and testing of the design prior to its release to the customer. The addition of any support logic needs to be quick and correct in order to not adversely impact the fabrication process. For example, one form of support logic that may be required is fuse compression/decompression logic. In this case, a fuse controller and its associated support logic are designed around static and dynamic random access memories (SRAMs and DRAMs, respectively) specified by the customer, and the entire set of logic is instantiated into an in-memory model of the logic network of the entire circuit. Logic network optimization software and manual edits of the network to add the support logic can alter the connections, requiring a verification check to be run during and after the design process. Verification of logic networks in very large scale integration (VLSI) designs to ensure correct connectivity is conventionally accomplished through simulation of the entire design or a subset of the design.

One situation that presents challenges relative to verification is where multiple domains are presented. For example, relative to the above-identified example of fuse logic, in some cases, where the customer has specified significant amounts of SRAM or DRAM, multiple fuse controller domains may be needed to fully support the blowing of fuses for redundancy. The checking required for two identical fuse domains, however, is much more complicated than for a single domain. For example, a properly configured design will have all signals from one fuse controller feeding the same set of SRAMs and DRAMs, and in some cases, the signal must return to the same fuse controller. All signals originating from a first fuse controller usually must only connect to logic cells which are also connected to the first fuse controller and not another fuse controller in the design. Similarly, a second fuse controller must not connect to any logic cell that has connections to the first fuse controller. Verification of this logic is therefore very cumbersome.

In view of the foregoing, there is a need in the art for a solution that allows verification of connectivity of added support logic.

### SUMMARY OF THE INVENTION

Keyword-based verification of proper connectivity of a circuit design including a plurality of cells is disclosed. In one embodiment, a method includes assigning a keyword to each relevant pin of the circuit design, the keyword indicates a verification rule for a domain starting at the relevant pin; tracing the domain starting at the relevant pin, including recording a circuit instance identifier of each cell encountered to generate a traced circuit instance set; and verifying proper connectivity using the verification rule and the traced circuit instance set. The keyword may also indicate a name that drives the creation of a domain, or a trace rule that instructs the tracing. If the traced circuit instance sets do not match the pre-defined relationships, the verification fails and the user is notified that the logic must be modified. The keyword-based verification can occur between domains of the same circuit or a traced circuit instance set can be compared to an expected set.

A first aspect of the invention provides a method of verifying proper connectivity of a circuit design including a plurality of cells, the method comprising the steps of: assigning a keyword to each relevant pin of the circuit design, the keyword indicating a verification rule for a domain starting at the relevant pin; tracing the domain starting at the relevant pin, including recording a circuit instance identifier of each cell encountered to generate a traced circuit instance set; and verifying proper connectivity using the verification rule and the traced circuit instance set.

A second aspect of the invention provides a system for verifying proper connectivity of a circuit design including a plurality of cells, the system comprising: means for assigning a keyword to each relevant pin of the circuit design, the keyword indicates a verification rule for a domain starting at the relevant pin; means for tracing the domain starting at the relevant pin, including recording a circuit instance identifier of each cell encountered to generate a traced circuit instance set; and means for verifying proper connectivity using the verification rule and the traced circuit instance set

A third aspect of the invention provides a program product stored on a computer-readable medium, which when executed, verifies proper connectivity of a circuit design including a plurality of cells, the program product comprising: program code for assigning a keyword to each relevant pin of the circuit design, the keyword indicates a verification rule for a domain starting at the relevant pin; program code for tracing the domain starting at the relevant pin, including recording a circuit instance identifier of each cell encountered to generate a traced circuit instance set; and program code for verifying proper connectivity using the verification rule and the traced circuit instance set.

A fourth aspect of the invention provides a computer-readable medium that includes computer program code to enable a computer infrastructure to verify proper connectivity of a circuit design including a plurality of cells, the computer-readable medium comprising computer program code for performing the method steps of the invention.

A fifth aspect of the invention provides a business method for verifying proper connectivity of a circuit design including a plurality of cells, the business method comprising managing a computer infrastructure that performs each of the steps of the invention; and receiving payment based on the managing step.

A sixth aspect of the invention provides a method of generating a system for verifying proper connectivity of a circuit design including a plurality of cells, the method comprising: obtaining a computer infrastructure; and deploying means for performing each of the steps of the invention to the computer infrastructure.

The illustrative aspects of the present invention are designed to solve the problems herein described and other problems not described that are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a block diagram of a keyword-based verification system according to one embodiment of the invention.

FIG. 2 shows a block diagram of an illustrative circuit design.

FIG. 3 shows a flow diagram illustrating one embodiment of an operational methodology according to the invention.

FIG. 4 shows a schematic diagram of an illustrative circuit for use in describing one embodiment of a method according to the invention.

It is noted that the drawings of the invention are not to scale. The drawings are intended to depict only typical aspects of the invention, and therefore should not be considered as limiting the scope of the invention. In the drawings, like numbering represents like elements.

### DETAILED DESCRIPTION

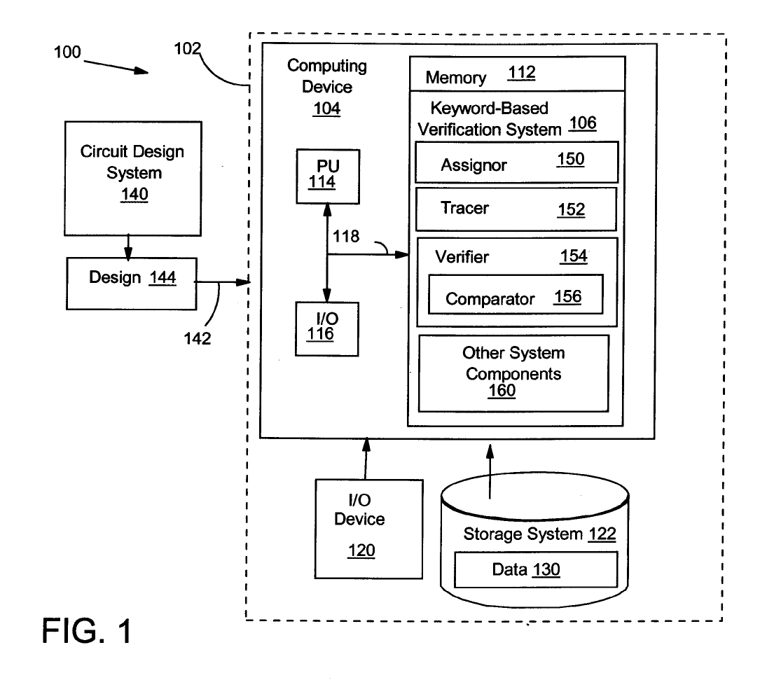

Turning to the drawings, FIG. 1 shows an illustrative environment 100 for verifying proper connectivity of a circuit design including a plurality of cells. To this extent, environment 100 includes a computer infrastructure 102 that can perform the various process steps described herein for verifying proper connectivity of a circuit design including a plurality of cells. In particular, computer infrastructure 102 is shown including a computing device 104 that comprises a keyword-based verification system 106, which enables computing device 104 to verify proper connectivity of a circuit design including a plurality of cells by performing the process steps of the invention.

Computing device 104 is shown including a memory 112, a processor 114, an input/output (I/O) interface 116, and a bus 118. Further, computing device 104 is shown in communication with an external I/O device/resource 120 and a storage system 122. As is known in the art, in general, processor 114 executes computer program code that is stored in memory 112 and/or storage system 122. While executing computer program code, processor 114 can read and/or write data, such as keyword-based verification, to/from memory 112, storage system 122, and/or I/O interface 116. Bus 118 provides a communications link between each of the components in computing device 104. I/O device 120 can comprise any device that enables a user to interact with computing device 104 or any device that enables computing device 104 to communicate with one or more other computing devices.

In any event, computing device 104 can comprise any general purpose computing article of manufacture capable of executing computer program code installed by a user (e.g., a personal computer, server, handheld device, etc.). However, it is understood that computing device 104 and keyword-based verification system 106 are only representative of various possible equivalent computing devices that may perform the various process steps of the invention. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in one embodiment, computer infrastructure 102 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

Environment 100 can further comprise a circuit design system 140 for generating a circuit design 144. Circuit design system 140 is shown in communication with computing device 104 over a communications link 142. As discussed above, communications link 142 can comprise any combination of various types of communications links as is known in the art. In one embodiment, keyword-based verification system 106 includes a computing device that is in communication with circuit design system 140 over a network. Regardless, it is understood that circuit design system 140 can comprise the same components (processor, memory, I/O interface, etc.) as shown for computing device 104. These components have not been separately shown and discussed for brevity.

As previously mentioned and discussed further below, keyword-based verification system 106 enables computing infrastructure 102 to verify proper connectivity of a circuit design including a plurality of cells. To this extent, keyword-based verification system 106 is shown including: a keyword assigner 150, a tracer 152 and a verifier 154 including a comparator 156. Other system components 160 may include any other peripheral functionality typically provided for now known verification systems but not explicitly described herein. Operation of each of these components is discussed further below. However, it is understood that some of the various systems shown in FIG. 1 can be implemented independently, combined, and/or stored in memory for one or more separate computing devices that are included in computer infrastructure 102. Further, it is understood that some of the systems and/or functionality may not be implemented, or additional systems and/or functionality may be included as part of environment 100.

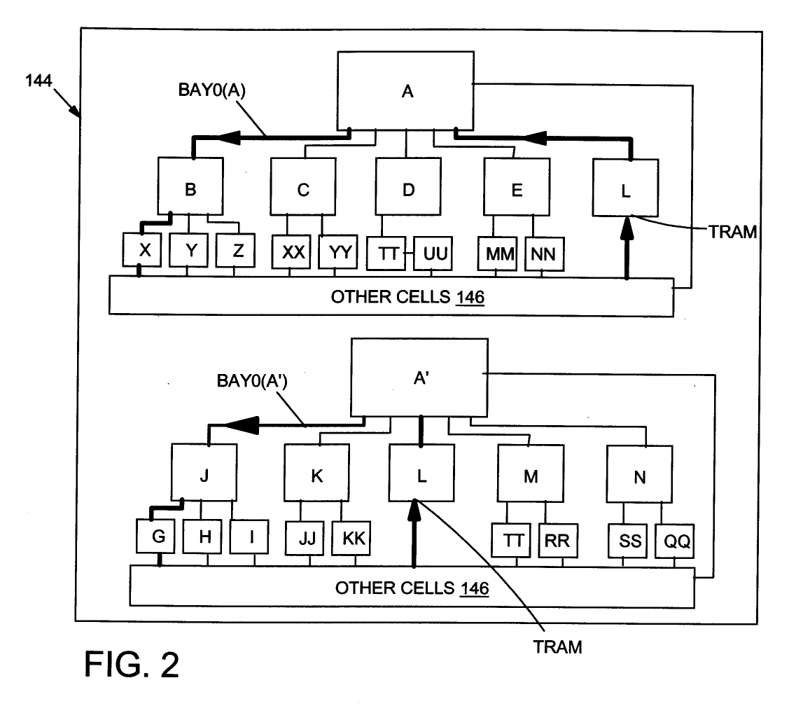

Referring to FIG. 2, a block diagram of an illustrative circuit design 144 is shown. In this design, duplicate base circuits A and A′ with different instantiations are shown. Each base circuit A and A′ is a very large circuit and has a large number of input and output pins, which are connected to many other circuit cells, e.g., B-E and L for base circuit A and J-N for base circuit A′. Each cell may also be connected to many other cells 146 in circuit design 144.

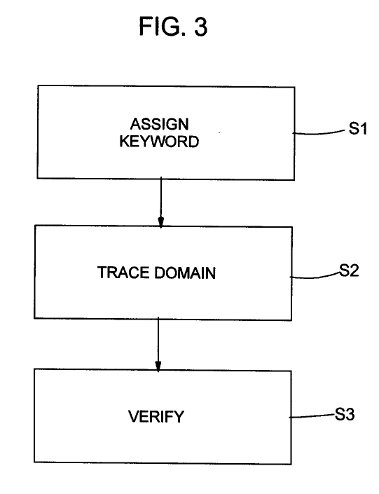

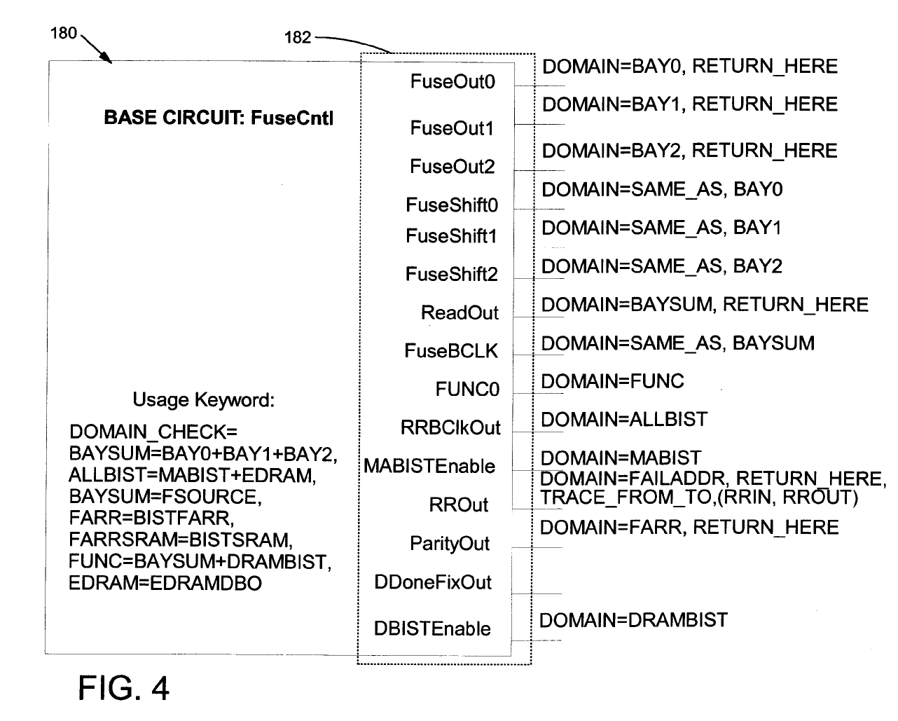

Turning now to FIGS. 1-4 together, one illustrative embodiment of an operational methodology of system 106 will now be described. FIG. 3 shows a flow diagram of the method, and FIG. 4 shows one illustrative rendition of a base circuit 180 from which tracing may begin. In this case, base circuit 180 is in the form of a fuse controller, entitled FuseCntl. It should be recognized, however, that the invention is not limited to any type of starting circuit design, and may be applied at a variety of different points within a particular circuit design. That is, the “base circuit” 180 need not have any particular structure or be a centralized starting point. In addition, the invention can be applied to practically any type of circuit design including a plurality of cells. The terms “circuit design” and “plurality of cells” are to be given their broadest possible interpretation, and may include any type of electrically conductive structure that provides a function (e.g., a fuse controller), a memory structure (e.g., SRAM, DRAM), or other electrical structure through which current will flow.

In a first step S1, assignor 150 assigns a keyword to each relevant pin of the circuit design. Assignor 150 may provide this task as part of circuit design system 140, or may be a separate component of keyword-based verification system 106. Assignor 150 may provide an interface for a circuit designer to indicate relevant pins, or may automatically assign keywords based on a knowledge base. As used herein, “relevant pin” indicates a pin 182 (inside phantom box) that either leads to a set of circuits (i.e., a domain) or is within a circuit design of interest for proper connectivity verification. As used herein, “domain” means a collection of circuit design cells within a circuit design 144 that is to be considered (e.g., a critical path). In the illustrative base circuit 180, shown in FIG. 4, the following pins are provided: FuseOut0, FuseOut1, FuseOut2, FuseShift0, FuseShift1, FuseShift2, ReadOut, FuseBCLK, FUNC0, RRBClkOut, MABISTEnable, RROut, ParityOut, DDoneFixOut, and DBISTEnable. In one embodiment, assignor 150 identifies each relevant pin 182 by an identifier, e.g., “DOMAIN=”. In FIG. 4, every pin except DDoneFixOut is considered a relevant pin.

A keyword may take a number of different forms, which may be used alone or in any combination. In a first preferred embodiment, an assigned keyword indicates a verification rule for the domain starting at the respective relevant pin 182. In this case, the verification rule indicates an expected relationship between a traced circuit instance set that is generated by the trace, as will be described in greater detail below. That is, different domains may have different relationships that can be easily stated in terms of a verification rule, without having to provide another name for a domain. For example, certain domains are supposed to be exactly identical (SAME_AS) or some are supposed to be a summation of each other (e.g., BAYSUM is a union of BAY0+BAY1+BAY2). For example, SAME_AS, BAY0 for pin FuseShift0 indicates that a domain including FuseShift0 is not to be treated as a named domain, but that it should be traced and verified to confirm that it is the same as domain BAY0. Other forms of verification rules are described below relative to the verifying step S3. In a second embodiment, an assigned keyword initiates or indicates a domain by indicating a name for the domain that starts at a relevant pin. For example, as shown in FIG. 4, base circuit 180 includes the following pin and name pairs: FuseOut0:BAY0, FuseOut1:BAY1, FuseOut2:BAY2, ReadOut:BAYSUM, FUNC0: FUNC, RRBClkOut:ALLBIST, MABISTEnable:MABIST, RROut:FAILADDR, ParityOut:FARR and DBISTEnable:DRAMBIST. A keyword in the form of a name allows identification of that domain.

In a third embodiment, also shown in FIG. 4, a keyword may include a trace rule for instructing the tracing (step S2, described below). Trace rules provide flexibility in terms of how domains are traced, and indicate an instruction for use by tracer 152. For example, tracer 152 may trace out of a circuit on pin 1 and record the next cell in line, and will then attempt to trace from the same pin, i.e., pin 1 of the cell. In some instances, however, it may be required for the tracing to proceed out of a different pin from the cell. In this case, a trace rule may instruct tracer 152 on special pin of the cell from which to continue tracing. For example, for pin RROut in FIG. 4, a trace rule TRACE_FROM_TO, (RRIN, RROUT) indicates to tracer 152 to trace from pin RRIN of an encountered cell to pin RROUT of that cell. In other examples, trace rules may exclude cells (EXCLUDE_FROM) or start a new trace and a new named domain (NEW_TRACE, (RR00, FARRSRAM)).

In a second step S2, tracer 152 traces a domain starting at the relevant pin, including recording a circuit instance identifier of each cell encountered to generate a traced circuit instance set. That is, a trace is started at each relevant pin of base circuit 180 and a record of the circuit instances (i.e., names) of the different cells encountered is recorded. As tracer 152 traces each domain, it identifies the circuit instance identifier of each cell it encounters, thus identifying each cell it encounters. The initial keyword on pin 182 triggers the tracing of a net to the next circuit. Tracer 152 will trace no further unless it finds one of two trace rule keywords: TRACE_TO or TRACE_FROM_TO. These new keywords on subsequent cells continually instruct tracer 152 where to trace next.

As tracer 152 traces, a record of the traced circuit instance set is generated. Oftentimes, each traced circuit instance set is a loop that ends back at base circuit 180 at which it started, however, that is not always necessary. Tracing may proceed through the plurality of cells and other structures also, such as memory elements (SRAMs/DRAMs).

In step S3, verifier 154 performs a verification of proper connectivity of the circuit design using the verification rule and the traced circuit instance set. Verification can take a variety of forms. In one embodiment, for each domain, a verification rule indicates an expected set relationship(s), entitled, for example, “DOMAIN_CHECK=”. The expected set relationship(s) for a respective domain is compared to the traced circuit instance set for the respective domain to verify whether the domain is structured as expected. This step can be carried out simply by verifier 154 comparing circuit instance identifiers using comparator 156, and noting differences. For example, one simplistic expected set relationship may be BAYSUM=BAY0+BAY1+BAY2. Note, BAY0, BAY1 and BAY2 may not be individual cells, but groups of cells—domains. The BAYSUM expected set relationship indicates that a traced circuit instance set for domain BAYSUM is expected to be a union of cells BAY0, BAY1 and BAY2. In this case, for the illustrative FuseCntl base circuit in FIG. 4, the domain for the ReadOut pin should be BAY0+BAY1+BAY2. If during the verification step, the traced circuit instance set for the ReadOut pin does not equal BAY0+BAY1+BAY2, then an error can be indicated and modifications made to circuit design 144.

In a more robust example of this verification rule implementation, a verification may include determining whether circuits for numerous circuit design cells, e.g., base circuits A and A′ and their respective networks, do not cross over. For example, in certain cells such as where support logic having numerous instantiations of similar circuits is added to a circuit design, it may be necessary to make sure the different instantiations do not share cells. Referring to the illustrative circuit design 144 in FIG. 2, for example, proper circuit design may mandate that base circuit A and any cell that is connected to base circuit A cannot be connected to base circuit A′, and base circuit A′ and any cell connected to base circuit A′ cannot be connected to base circuit A. No connections of the network for base circuit A should cross over and connect to the network for base circuit A′. In this case, the different traced circuit instance sets for base circuit A can be compared to the traced circuit instance sets for the corresponding circuits in base circuit A′ by comparator 156, and if there is an overlap, an error can be indicated. That is, if a traced circuit instance set for base circuit A includes at least one of the same circuit instances from a corresponding traced circuit instance set for base circuit A′, an error is indicated. For example, assume for base circuit A, a traced circuit instance set for domain BAY0(A) included cells B, X, L, as shown by the thicker trace lines and arrows. Then for base circuit A′, a traced circuit instance set for domain BAY0(A′) includes Y, G, L, as shown by the thicker trace lines and arrows. When a comparison is performed by comparator 156 of verifier 154, the circuit instance identifier, e.g., TRAM, for the L cell would indicate that base circuit A and base circuit A′ are inappropriately sharing cell L, and a re-design would be indicated. In a variation of this embodiment, there may not be a single verification rule that does a comparison of a domain traced from, for example, base circuit A to a domain traced from base circuit A′. However, if all of the verification rules on base circuit A (e.g., BAYSUM=BAY0+BAY1+BAY2, ALLBIST=MABIST+EDRAM, BAYSUM=FSOURCE, etc.) are considered, and all of the domains thereof are verified, then verifier 154 indicates no overlap between base circuits A and A′. Here, verifier 154 relies upon a clear understanding of the connectivity of all cells in the circuit design, i.e., network.

In another embodiment, a verification rule may indicate that verifier 154 should verify a domain by comparison using comparator 156 to another domain's traced circuit instance set. For example, for a domain starting pin having a SAME_AS, BAY0 verification rule, a traced circuit instance set for the relevant pin is compared to the traced circuit instance set for a named BAY0 domain, and compared to confirm they are the same. In another example, a verification rule entitled RETURN_HERE verifies whether the starting cell is the same as the ending cell. Referring to FIG. 4, for example, FuseOut0, FuseOut1 and FuseOut2 indicates that a trace for domains BAY0, BAY1 and BAY2, respectively, from those relevant pins should return to a different pin on the same usage as the starting pin. If not, an error is indicated.

It is understood that the order of the above-described steps is only illustrative. To this extent, one or more steps can be performed in parallel, in a different order, at a remote time, etc. Further, one or more of the steps may not be performed in various embodiments of the invention.

While shown and described herein as a method and system for verifying proper connectivity of a circuit design including a plurality of cells, it is understood that the invention further provides various alternative embodiments. For example, in one embodiment, the invention provides a computer-readable medium that includes computer program code to enable a computer infrastructure to verify proper connectivity of a circuit design including a plurality of cells. To this extent, the computer-readable medium includes program code, such as keyword-based verification system 106 (FIG. 1), which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 1) and/or storage system 122 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to verify proper connectivity of a circuit design including a plurality of cells as described above. In this case, the service provider can manage (e.g., create, maintain, support, etc.) a computer infrastructure, such as computer infrastructure 102 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for verifying proper connectivity of a circuit design including a plurality of cells. In this case, a computer infrastructure, such as computer infrastructure 102 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 104 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of verifying proper connectivity of a circuit design including a plurality of cells, the method comprising:
assigning a keyword to each relevant pin of the circuit design, the keyword indicating a verification rule for a domain starting at the relevant pin;
tracing the domain starting at the relevant pin, including recording a circuit instance identifier of each cell encountered to generate a traced circuit instance set; and
verifying proper connectivity using the verification rule and the traced circuit instance set.

2. The method of claim 1, wherein the keyword further indicates a trace rule for instructing the tracing.

3. The method of claim 1, wherein the verifying includes confirming whether the tracing returns to a cell from which the tracing began.

4. The method of claim 1, wherein the keyword also indicates a name of a domain for the trace starting at the relevant pin.

5. The method of claim 1, wherein the verifying includes confirming whether the traced circuit instance set of a first domain does not include any cell of a second domain.

6. The method of claim 1, wherein the verifying includes confirming whether the traced circuit instance set is identical to an expected set relationship.

7. A method of generating a system for verifying proper connectivity of a circuit design including a plurality of cells, the method comprising:
obtaining a computer infrastructure; and
for each method process of claim 1, deploying a means for performing the method process to the computer infrastructure.

8. A computer-readable medium for enabling a computer infrastructure to verify proper connectivity of a circuit design including a plurality of cells, the computer-readable medium comprising computer program code for performing the method processes of claim 1.

9. A system for verifying proper connectivity of a circuit design including a plurality of cells, the system comprising:
means for assigning a keyword to each relevant pin of the circuit design, the keyword indicates a verification rule for a domain starting at the relevant pin;
means for tracing the domain starting at the relevant pin, including recording a circuit instance identifier of each cell encountered to generate a traced circuit instance set; and
means for verifying proper connectivity using the verification rule and the traced circuit instance set.

10. The system of claim 9, wherein the keyword further indicates a trace rule for instructing the tracing.

11. The system of claim 9, wherein the verifying means confirms whether the tracing returns to a cell from which the tracing began.

12. The system of claim 9, wherein the keyword also indicates a name of a domain for the trace starting at the relevant pin.

13. The system of claim 9, wherein the verifying means confirms whether the traced circuit instance set of a first domain does not include any cell of a second domain.

14. The system of claim 9, wherein the verifying means confirms whether the traced circuit instance set is identical to an expected set relationship.

15. A program product stored on a computer-readable medium, which when executed, verifies proper connectivity of a circuit design including a plurality of cells, the program product comprising:
program code for assigning a keyword to each relevant pin of the circuit design, the keyword indicates a verification rule for a domain starting at the relevant pin;
program code for tracing the domain starting at the relevant pin, including recording a circuit instance identifier of each cell encountered to generate a traced circuit instance set; and
program code for verifying proper connectivity using the verification rule and the traced circuit instance set.

16. The program product of claim 15, wherein the keyword further indicates a trace rule for instructing the tracing.

17. The program product of claim 15, wherein the verifying code confirms whether the tracing returns to a cell from which the tracing began.

18. The program product of claim 15, wherein the keyword also indicates a name of a domain for the trace starting at the relevant pin.

19. The program product of claim 15, wherein the verifying code confirms whether the traced circuit instance set of a first domain does not include any circuit instances of a second domain.

20. The program product of claim 15, wherein the verifying code confirms whether the traced circuit instance set is identical to an expected set relationship.
